(19) United States
(12) Patent Application Publication
(10) Pub. No.: US 2023/0237688 A1
(43) Pub. Date: Jul. 27, 2023

(54) SYSTEM AND METHOD OF EFFICIENT OBJECT DETECTION IN IMAGE OR VIDEO

(71) Applicant: Beamr Imaging Ltd, Herzeliya Pituach (IL)

(72) Inventors: Sergey PYKO, St. Petersburg (RU); Boris FILIPPOV, St. Petersburg (RU); Alexander IVANOV, Minsk (BY); Tamar SHOHAM, Zichron Yaakov (IL)

(21) Appl. No.: 17/933,718

(22) Filed: Sep. 20, 2022

(30) Foreign Application Priority Data
Jan. 26, 2022 (RU) RU2022101752

(51) Int. Cl. G06T 7/70

(52) U.S. Cl. CPC G06T 7/70; G06T 2207/30201; G06T 2207/10016

(57) ABSTRACT

There are provided computerized systems and methods for detection of objects in a one or more images or video frames, which require reduced power or computational cost compared to existing methods. The proposed approach uses a set of per frame detection anchors which are split into a primary sub-set and one or more secondary sub-sets. For each key frame a full detection process for each of the detection anchors in primary subset is performed, determining for each detection anchor whether it corresponds to a detected object, and updating a detected object data structure accordingly. For each non ‘key-frame’, a history based fast detection process for each of the detection anchors in the primary subset is performed, where it is first determined whether a criterion for temporal based early exit is met and whether the detection anchor corresponds to a detected object and updating the detected object data structure according to detection results. Then for each of the detection anchors in each of one or more secondary subsets, it is first determined whether a criterion for spatial early exit is met and whether the detection anchor corresponds to a detected object, and updating the data structure according to detection results.

### TECHNICAL FIELD

The presently disclosed subject matter relates generally to the field of object detection in image or video, and more specifically, to methods and systems of efficient and fast object detection in image or video using parallelized computing.

### BACKGROUND

Object detection is the process which identifies presence of a certain object, for example face, car, chair, dog etc. in digital images or video content. As face detection is a well known and commonly used object detection application, we have chosen for the sake of clarity to focus on this example throughout the description. Thus, while in the presently disclosed subject matter we will focus the discussion on face detection, these same algorithms and teachings may be readily used for any object detection task in image or video.

Face detection is the process which identifies presence of human faces in digital images or video content. A face detection system perform analysis of an image or video frame and provides indication regarding which pixels or locations correspond to faces. Many imaging and video applications can benefit from accurate and fast detection of faces. Detection of faces can be used as a preliminary step for face recognition, as well as for tagging of content, and helping to identify Region-Of-Interest (ROI) in the image or video frame. This can then be used to improve subsequent picture processing such as better capture, cropping, quality enhancement, super resolution and compression to name but a few. In addition, location of faces may be used to configure analysis of the content, such as for the purpose of quality evaluation using objective quality measures.

Performing face detection in an image is sometimes done using algorithms implemented in software and running on a Central Processing Unit. Examples include the widely used open-source OpenCV face detection functions, or one of the various available proprietary software packages such as Lux and FaceSDK. However, when fast, low power solutions are needed for face detection, dedicated hardware is often used, for example as proposed by Theocharides et. al. While software implementations offer very high flexibility, and can be easily adapted, they are computationally intensive, and for high resolution images or video can introduce a significant drain on the system resources. The hardware solutions are inflexible and require availability and integration with specific hardware, which may not be applicable in many use cases.

Graphic Processing Units (GPUs) have been found to be a good platform to provide low-cost solutions to tasks which can be highly parallelized. The GPU architecture enables performing multiple identical tasks quickly and efficiently. Face detection algorithms often tend to use sequential and/or hierarchical (top down or bottom up) approaches, which are less suitable for efficient deployment in a GPU. We propose a face detection approach where the strengths of parallelized computing, such as is available on a GPU, can be utilized to obtain fast and accurate face detection at low compute cost.

Note that the following groups of terms are used interchangeably in this description: {detection anchor, anchor}, {video frame; image; picture}, {key-frame, INTRA frame, scene-change} and {non key frame, inter frame, subsequent frame}.

### General Description

In accordance with certain aspects of the presently disclosed subject matter, there is provided a computerized method for object detection in one or more video frames, the method comprising performing initialization comprising obtaining a data structure to hold object detection information for each position in a video frame, and a set of detection anchors each representative of at least a position in the video frame to be considered for detection, wherein the set of detection anchors is divided into a primary sub-set and one or more secondary sub-sets, and for a given video frame of the one or more video frames, performing processing, wherein the processing comprises the following: For each detection anchor in said primary sub-set, performing a full detection process, determining whether the detection anchor corresponds to a detected object, and updating the data structure according to said determination. For each detection anchor in each secondary sub-set of said one or more secondary sub-sets, performing a partial detection process, comprising determining if a criterion for spatial early exit is met and whether the detection anchor corresponds to a detected object, and updating the data structure according to said determination. The method further comprises outputting said data structure providing the information on one or more detected objects.

In addition to the above features, the method according to this aspect of the presently disclosed subject matter can comprise one or more of features (a) to (i) listed below, in any desired combination or permutation which is technically possible:
(a) The detected object is a face.
(b) The initialization further comprises obtaining a face map to hold binary indications for respective positions in the video frame, and upon completion of said processing, performing analysis of the data structure and updating the face map so that the binary indications correspond to positions where face was or was not detected in said given video frame.
(c) In cases where the given video frame is not considered a key-frame, said full detection process for detection anchors in said primary sub-set is replaced with a history-based partial detection process, by determining for each detection anchor in said primary sub-set if a criterion for temporal-based early exit is met and whether the detection anchor corresponds to a detected face, and updating the data structure according to said determination.
(d) The full detection process is a multi-scale cascade-based detection scheme, and the initialization further comprises obtaining face detection cascades for each scale to be used, and each detection anchor in said set of detection anchors further comprises a corresponding scale value.
(e) The set of detection anchors is divided into a primary sub-set and one or more secondary sub-sets such that the primary sub-set and the one or more secondary sub-sets are spatially interleaved.
(f) The primary sub-set and a secondary sub-set are spatially interleaved such that one sub-set corresponds to even detection anchor positions and the other to odd detection anchor positions.
(g) The criterion for spatial early exit comprises evaluating whether a face was consistently detected in one or more detection anchors in the primary sub-set that are adjacent to the detection anchor in the secondary sub-set.
(h) A face was consistently detected in response to the face being detected in the detection anchors in the primary sub-set on both sides of the detection anchor of the secondary sub-set.
(i) The criterion for temporal early exit comprises evaluating whether a face was detected in co-located or surrounding detection anchors in one or more preceding video frames of the given video frame.

In accordance with yet other aspects of the presently disclosed subject matter, there is provided a computerized system for detection of objects in one or more images or video frames comprising a processor configured to perform initializations comprising: Preparing memory for a Detected Object Data structure, which for each position in the image will hold indication of detected object and object size; Selecting a set of per frame detection anchors, each detection anchor comprising at least a position in the frame to be considered for detection, and splitting the set of detection anchors into a primary sub-set and one or more secondary sub-sets. And, for each frame or image perform processing comprising: Obtaining an image or video frame, and then if frame is a ‘key-frame’, performing full detection process for each of the detection anchors in said primary subset, determining for each anchor whether it corresponds to a detected object, and updating the Detected Object Data accordingly. Otherwise, for non ‘key-frame’, performing a history based fast detection process for each of the detection anchors in said primary subset, comprising determining for each anchor if criteria for temporal based early exit is met and whether it corresponds to a detected object, and updating the Detected Object Data accordingly. Performing fast detection process for each of the detection anchors in each of said one or more secondary subsets, comprising determining for each anchor if criteria for spatial early exit is met and whether it corresponds to a detected object, updating the Detected Object Data accordingly, and outputting the Detected Object Data, or a processed version thereof.

In addition to the above features, the system according to this aspect of the presently disclosed subject matter can comprise one or more of features (i) to (x) listed below, in any desired combination or permutation which is technically possible:
(i) The object to detect is a face.
(ii) The Detected Object or Face Data is processed to yield an Object or Face Map indicating pixels that correspond to detected objects or faces in said image or video frame.
(iii) Initialization further comprises preparing memory for a Face Map, which for each position in the image will hold a binary indication if face is present or not, and upon completion of the frame processing the Detected Face Data is analyzed to yield a Face Map indicating pixels that correspond to detected faces in said image or video frame.
(iv) The detection process is a multi-scale cascade based detection scheme, and wherein initializations include calculating the face detection cascades for each scale to be used, and wherein said anchors further comprise a corresponding scale value.
(v) The splitting into sub-sets divides the anchors into spatially interleaved sub-sets.
(vi) The splitting into sub-sets divides the anchors into even and odd positions.
(vii) The criteria for spatial early exit comprises evaluating whether face was consistently detected in the adjacent anchors of the primary set.
(viii) Consistently detected in the adjacent anchors corresponds to face being detected in the primary set anchors on both sides, e.g. left and right or above and below, of the secondary set anchor.
(ix) The criteria for temporal early exit comprises evaluating whether face was detected in co-located and surrounding anchors in preceding one or more images or video frames.
(x) The anchor positions are selected so that for a given number of anchors the distance from each pixel in the image to the closest anchor is minimized

### BRIEF DESCRIPTION OF THE DRAWINGS

The above needs are at least partially met through provision of the apparatus and method for face detection described in the following detailed description, particularly when studied in conjunction with the drawings.

In order to understand the presently disclosed subject matter and to see how it may be carried out in practice, embodiments will now be described, by way of non-limiting example only, with reference to the accompanying drawings, in which:

FIG. 1A illustrates a block diagram of a computerized system for object detection in accordance with certain embodiments of the presently disclosed subject matter;

FIG. 1B illustrates a block diagram of a computerized system for face detection in accordance with certain embodiments of the presently disclosed subject matter:

FIG. 2 illustrates a block diagram of a computerized system for face detection with tracking in accordance with certain embodiments of the presently disclosed subject matter;

FIG. 3 illustrates a block diagram of a computerized system for cascade based face detection in accordance with certain embodiments of the presently disclosed subject matter;

FIG. 4 illustrates a generalized flowchart of a face detection system in accordance with certain embodiments of the presently disclosed subject matter;

FIG. 5 illustrates a generalized flowchart spatial based partial detection in accordance with certain embodiments of the presently disclosed subject matter;

FIG. 6 illustrates a generalized flowchart of temporally based partial detection as part of a face detection system in accordance with certain embodiments of the presently disclosed subject matter;

FIG. 7 illustrates concepts and components of Haar Cascade based face detection in accordance with certain embodiments of the presently disclosed subject matter;

FIG. 8 illustrates an example of spatial early exit in accordance with certain embodiments of the presently disclosed subject matter;

FIG. 9A illustrates an example of data preparation for temporal early exit in accordance with certain embodiments of the presently disclosed subject matter;

FIG. 9B illustrates an example of a possible implementation of temporal early exit, further comprising spiral search, in accordance with certain embodiments of the presently disclosed subject matter;

FIG. 9C illustrates an example of detection coverage areas, or detection footprint, in accordance with certain embodiments of the presently disclosed subject matter;

FIG. 10 illustrates an example of the process of creating a Face Map using the information stored in the Face Detection Data in accordance with certain embodiments of the presently disclosed subject matter;

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have their ordinary technical meaning as are accorded to such terms and expressions by persons skilled in the technical field as set forth above, except where different specific meanings have otherwise been set forth herein.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “receiving”, “obtaining”, “initializing”, “setting”, “allocating”, “processing”, “calculating”, “computing”, “estimating”, “configuring”, “generating”, “using”, “extracting”, “performing”, “placing”, “adding”, “splitting”, “repeating”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the system/apparatus and parts thereof as well as the control circuit/circuitry therein disclosed in the present application.

The terms “non-transitory memory” and “non-transitory storage medium” used herein should be expansively construed to cover any volatile or non-volatile computer memory suitable to the presently disclosed subject matter.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the following detailed description, numerous specific details are set forth in order to provide a thorough understanding of the methods and apparatus.

The term early exit, which is used repeatedly throughout this description is well known to those skilled in the art. It refers to an optimization technique which enables reducing the required algorithm computations by identifying cases when there is no need to complete all steps of an algorithm and the decision can be made at an earlier stage, when the algorithm can terminate or exit.

Generally speaking, pursuant to these various embodiments, the input to the system described herein are one or more images or video frames and the output of the system is configured to provide information regarding the presence and location of objects to be detected. It will be noted that some of the operations described herein do not relate to the novel aspects of the invention but are provided for the sake of completeness and clarity. It will also be noted that for most of the description we will focus on Face detection, but the described subject material applies to the more general object detection in the same manner.

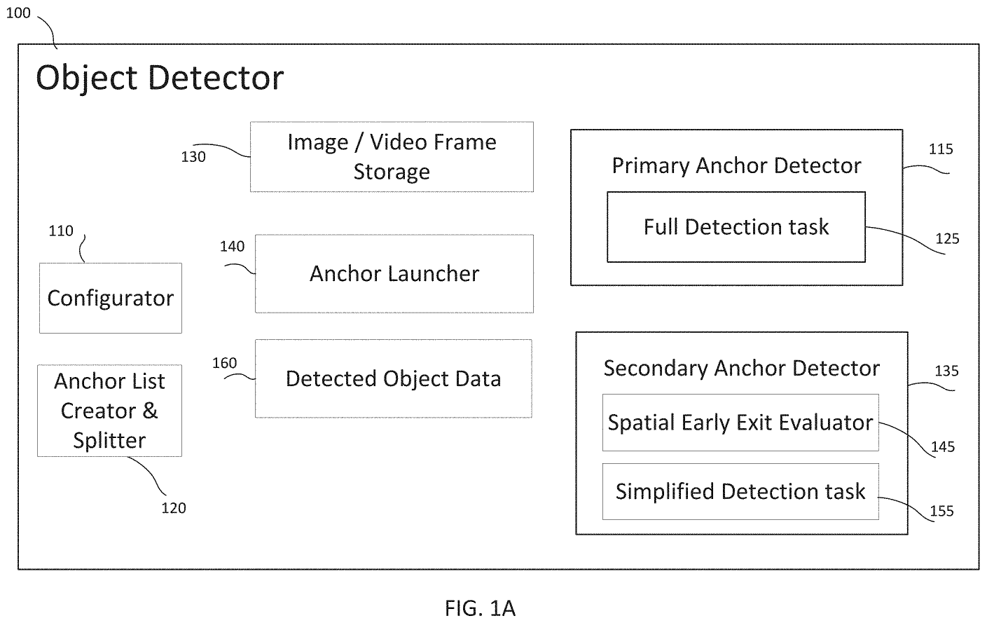

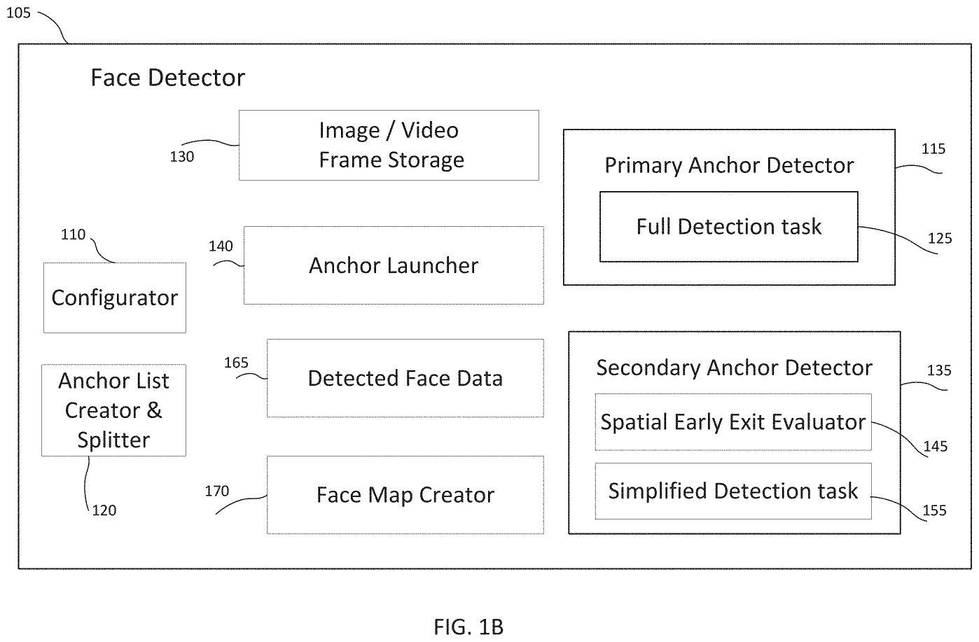

Referring now to the drawings, in FIG. 1A, there is illustrated a block diagram of a computerized system for object detection in accordance with certain embodiments of the presently disclosed subject matter. There is presented an enabling computer-based apparatus/system 100 configured to perform object detection. In some embodiments, this system may comprise a Configurator block 110 which configures the object detection process, for example by setting the minimum and maximum sizes of the objects to detect, configuring the detectors to be used such as frontal and/or profile detection etc. According to the frame dimensions and the configuration or setup, the Anchor List Creator & Splitter 120 first creates a list of detection anchors, or anchors, which corresponds to all positions in the frame that may be considered as origin points for detection. The anchor positions may be selected so that for a given number of anchors, the distance from each pixel in the image to the closest anchor, is minimized.

Then these are split into a primary sub-group of anchors and one or more secondary sub-groups of anchors. The split is done in a way that creates interleaved sub-sets, making it possible to use detection results information from anchors in the primary sub-set in order to perform fast and efficient detection for anchors in the secondary sub-set(s). In a non-limiting example, we could decide starting at the first anchor, every second anchor position belongs to the primary sub-set, while the remaining anchors comprise a secondary sub-set.

Upon receiving an input image or video frame, it can be placed in the Image/Video Frame Storage 130. Then for each anchor the Anchor Launcher 140 can control the process required for that anchor. The launcher supports high level of parallelism by launching multiple anchors in parallel. This results in very high detector efficiency at low latency when executing the detector on infrastructure that supports parallel processing, such as a GPU. It should be noted that the Anchor Launcher may be replaced with any other control mechanism which will invoke detection process for each of the anchors in the frame.

As further shown in FIG. 1A, the object detector further comprises a Primary Anchor Detector 115, which corresponds to the Anchor detection process applied to Anchors in the primary subset, and a Secondary Anchor Detector 135, which corresponds to the Anchor detection process applied to Anchors in a secondary subset. These may further comprise one or more internal blocks, details of which follow shortly. The Object Detector may further comprise Detected Object Data 160, a data structure to hold object detection information for each position in a video frame, which is allocated once upon launch of the detector, and is written by the Anchor detector Processes 115 and 135. The Detected Object Data contains the information regarding which anchors correspond to a detection, as well as details of the detection type, size, etc. The Object Detector may directly output the information stored in Detected Object Data, or may output a processed version of it.

The primary Anchor detector 115 depicts the process applied to primary anchors when invoked by the Anchor Launcher or by any other selected control process. For these anchors the Full Detection task 125 is performed according to the configuration of the Object Detector. The Secondary Anchor Detector 135 may further comprise a Spatial Early Exit Evaluator 145, configured to assess whether a decision regarding presence of the object in this anchor may be made based on the detection results of the primary anchors in its spatial vicinity, or by evaluating whether the object was consistently detected in the adjacent anchors of the primary set. In a non-limiting example for the sake of clarity only, if the subsets consist of every other anchor in each row creating a checkerboard type split, we may examine the detection in the primary anchor to the left and right, above and below the current secondary anchor. If the surrounding primary anchors have matching detection data, for example face was detected to the left and to the right, the secondary anchor between them is set accordingly. The detection for this anchor is now complete, without any actual detection task being applied. In another example, the detection status of the surrounding primary anchors may be inconclusive, in which case the Simplified Detection Task 155 may be applied. The Simplified Detection Task performs only a partial detection process, which has lower computational complexity than the full detection task. In a non-limiting example, when detecting different objects in the image or video, the object detected in primary anchors surrounding the current secondary anchor may be the only object we attempt to detect. For instance, if we are looking for cars, trucks and pedestrians, and a pedestrian was detected to the left, we may apply only pedestrian detection at this anchor. Similarly other detection properties such as orientation, size, category, color etc. of detected object(s) in primary anchors which are in the vicinity of the target secondary anchor can be used to simplify the detection process for the target anchor. In another example, information from adjacent detections may be used to change the processing order: if an object of a certain type was found in neighboring anchors, then checking the target anchor should begin with checking this object type, and if there is a positive detection, early exit may be applied. Further examples and details will be provided below for both spatial early exit and simplified detection.

Turning now to the drawings, in FIG. 1B, there is illustrated a block diagram of a computerized system for face detection in accordance with certain embodiments of the presently disclosed subject matter. There is presented an enabling computer-based apparatus/system 105 configured to perform face detection. In some embodiments, this system may comprise a Configurator block 110 which configures the face detection process, for example by setting the minimum and maximum sizes of the faces to detect, configuring the detectors to be used such as frontal and/or profile detection etc.

As further shown in FIG. 1B, the face detector may further comprise a Detected Face Data 165, a data structure to hold face detection information for each position in a video frame, which is allocated once upon launch of the detector, and is written by the Anchor detector Processes 115 and 135. The Detected Face Data contains the information regarding which anchors correspond to a detection, as well as details of the detection type, size, etc.

Optionally, the Face Detector may further comprise a Face Map Creator 170 which uses the Detected Face Data structure to create a face map for the frame, indicating which positions or pixels in the frame correspond to a detected face. For example, the Face map may have the same dimensions as the frame and be set to a value of one for pixels corresponding to detected faces, and zero for all other pixels. Alternatively, the face map me have any other format which indicates the positions and sizes of detected faces in the image. In yet other embodiments, the Face Detector may directly output the information stored in Detected Face Data.

The remaining blocks in the Face Detector are identical those in FIG. 1A, wherein the object is specified to be a face. Therefore, for the sake of brevity, we will not repeat their description here.

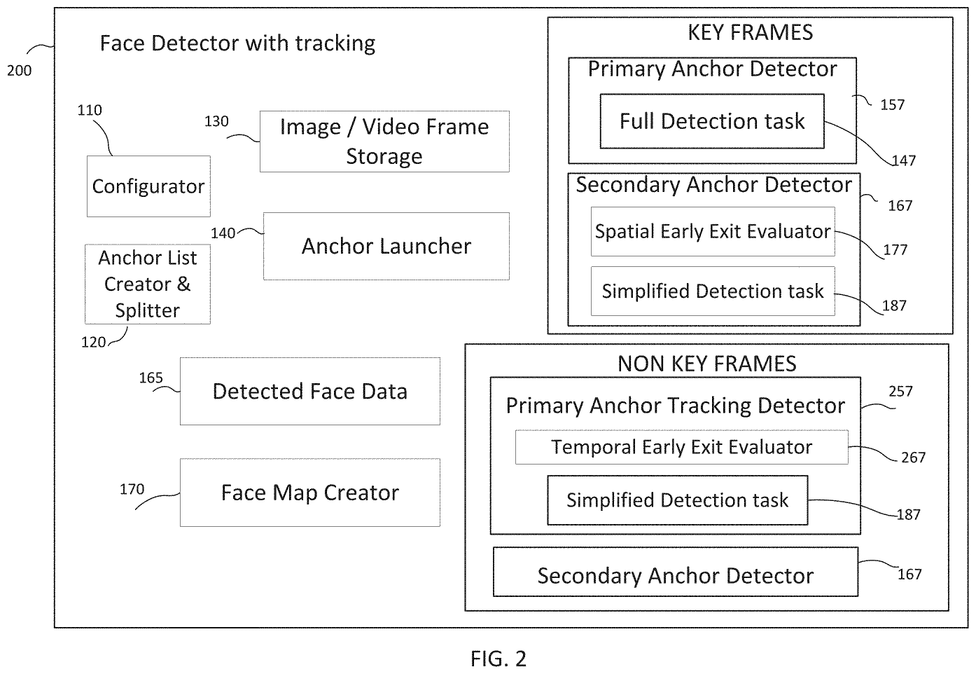

Turning now to FIG. 2, there is illustrated a block diagram of a computerized system for face detection with tracking in accordance with certain embodiments of the presently disclosed subject matter. There is presented an enabling computer-based apparatus/system 200 configured to perform face detection of a sequence of images or video frames. Many of the blocks of FIG. 2 correspond to blocks in FIG. 1A and FIG. 1B, and for the sake of brevity will not be repeated.

When processing a sequence of images or video frames, the term ‘key-frame’ is often used to refer to a frame that does not have corresponding previous frames, or a history. For example, the first frame in a sequence will always be a key-frame. Additionally, the first frame of a new scene, or the frame at a scene-change point in the sequence, is also often considered a key-frame. Compressed video streams often use the term key-frame to describe any frame which is not dependent or predicted using frames previously encountered. In the scope of the presently disclosed subject matter, a ‘key-frame’ is a frame where face detection is applied using information only from the anchors in the current frame, as depicted in FIG. 1A. Other frames, termed ‘non key-frame’, are frames where we assume there is history, or data/knowledge available from previously processed frames which belong to a similar scene, and wherein the detection results of previous frame(s) are utilized to increase the efficiency of the detection in the current non key frame.

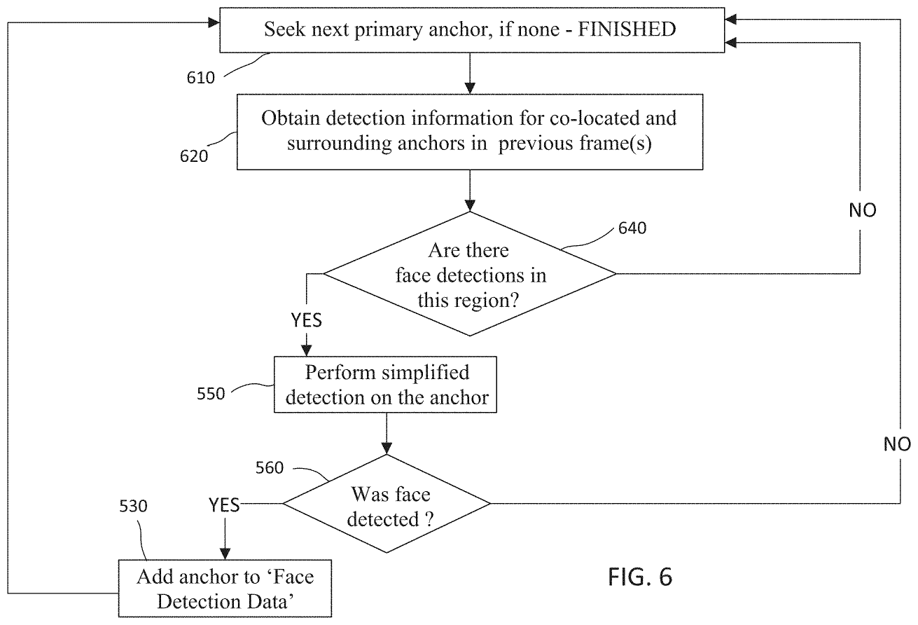

Non key frames may utilize the same Anchor List Creator and Splitter 120 used by key frames, resulting in primary anchors and one or more sets of secondary anchors. For the secondary anchors the detection process is similar to that of the Secondary Anchor Detector 167, used for key frames. For non key frames processing of primary anchors is performed by the Primary Anchor Tracking Detector 257. A Temporal Early Exit Evaluator 267, is configured to assess whether a decision regarding presence of face in this anchor may be made based on the detection results of anchors in preceding frame(s), or, by evaluating whether face was detected in co-located and surrounding anchors in preceding one or more images or video frames. In a non-limiting example for the sake of clarity only, this could correspond to checking whether face was detected in the co-located anchor in the previous frame, and setting the face detection for this anchor to match the detection in the previous frame without requiring any further detection process. In another example, this could correspond to determining whether face was detected in at least one anchor in the X by Y region surrounding the co-located anchor in any of the previous Z frames, where for example X=Y=5 and Z=2. If not, we may determine there is no face in this anchor and consider the anchor detection complete, otherwise we may use information of the corresponding detection to invoke a Simplified Detection task 187. Further detail on temporal early exit will be provided in the context of the description of FIG. 6.

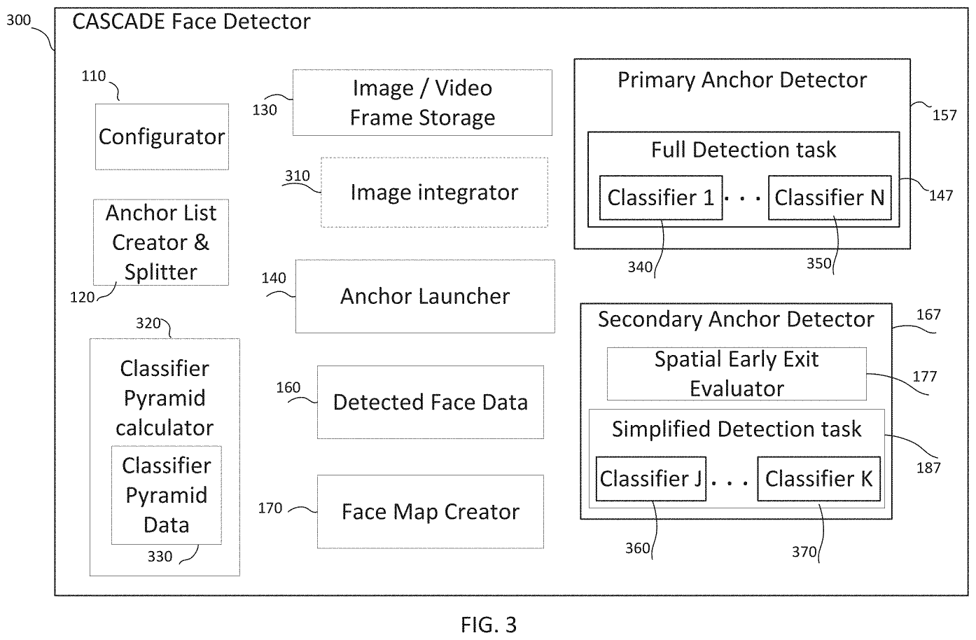

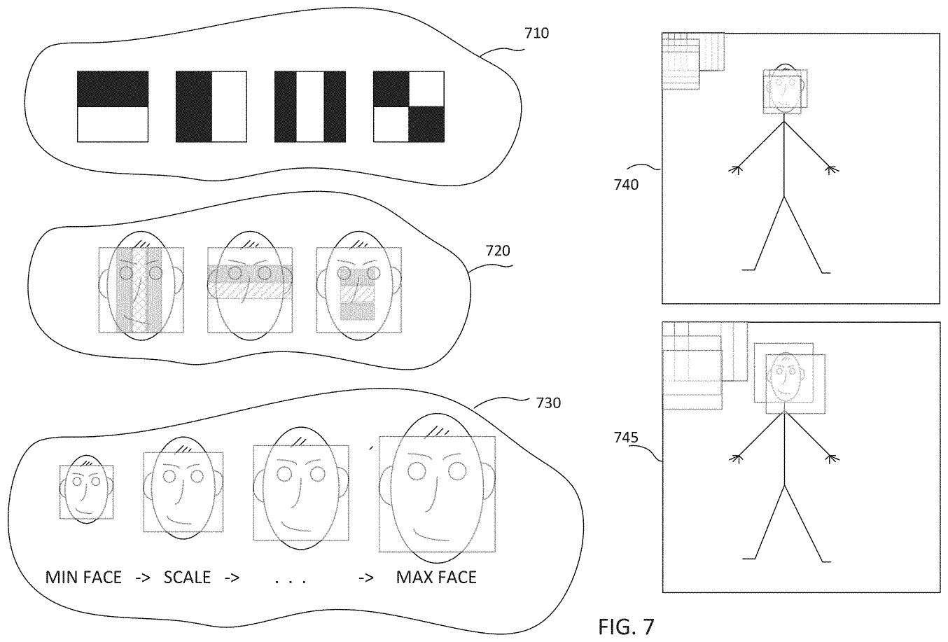

Turning now to FIG. 3, there is illustrated a block diagram of a computerized system for cascade-based face detection in accordance with certain embodiments of the presently disclosed subject matter. As is known to those skilled in the art, a common method for face detection is to create a cascade classifier built upon a series of simple classifiers. To better understand some aspects of the presently disclosed subject matter, a brief explanation of face detection using cascade classifiers will now be provided, referring to FIG. 7 where needed.

One well known algorithm for cascade based face detection is the Viola-Jones algorithm which uses Haar features, a.k.a Haar filters or cascades, samples of which are illustrated by way of example in 710. These are quite simple rectangular filters, and commonly used for face detection tasks due to their simplicity and ability to identify presence of edge, line and corner features, and can correspond well to features present in aligned faces as illustrated by way of example in 720. These Haar filter outputs, or Haar features, may be used as a low-level feature set, or weak classifiers. A Machine Learning algorithm known as AdaBoost, which creates a strong classifier by combining multiple weak classifiers, is applied to the many low-level, simple features, to reliably determine whether a face is present. For efficiency a cascaded classification system is used, and the process of detecting a face is split into multiple stages, with each stage increasing the certainty of the detection. First the image area, block, or subregion enters the cascade, and is evaluated by the first stage. If that stage evaluates the subregion as positive, meaning that it thinks it contains a face, the output of the stage is “maybe”. When a subregion gets a “maybe”, it is sent to the next stage of the cascade and the process continues as such till we reach the last stage. If all sub-classifiers in the cascade approve the image, it is finally classified as a human face and is presented to the user as a detection. For this type of algorithm, generally a training process is first required, using marked data to create the classifiers, then these classifiers can be applied for actual detection. OpenCV offers several trained Haar based cascade classifier models, saved as XML files, which can be used as an alternative to creating and training face detection models from scratch. These classifiers include multiple variants, where some target detection of profile face, others frontal face. Particularly when the target face detection is not ‘trivial’, different classifiers may succeed in the detection while other fail.

A face detection cascade is essentially trained to detect a face of particular size, which is centralized and boxed in the subregion. In order to be able to detect faces of different sizes, the image can be resized, or scaled, to a few different sizes and the same size classifier will be applied at each scale. Alternatively, the classifiers can be scaled and applied at their different scales to the full-size subregions of the image, as illustrated in 730. Further, to be able to detect faces in different locations in the image, these classifiers are applied to multiple image areas or subregions. The first sub-region is generally located at the frame origin, then we progress by stepSize along the first row of the image, to create multiple areas with distance of stepSize between them. Upon reaching the end of the row, we return to the origin and shift stepSize down, and proceed along the next row similarly. This process is repeated until the image has been covered. Note, that when applying multiple scales, the stepSize will be adjusted according to the scale as well. This detection grid, or multiple points of origin and subregion sizes is illustrated in 740 for smaller scale and 745 for a larger scale.

Returning now to FIG. 3, according to certain embodiments of the of the presently disclosed subject matter, cascade-based face detection is used. There is presented an enabling computer-based apparatus/system 300 configured to perform cascade based face detection of a single image or a sequence of images or video frames. Many of the blocks of FIG. 3 correspond to blocks in FIG. 1A and FIG. 1B, and for the sake of brevity will not be repeated here. Also it is to be understood, that the processing of non-key frames illustrated in FIG. 2 may be used in this cascade based classifier, and is not illustrated in FIG. 3 nor described in this section only to avoid repetition. The configurator 110 in FIG. 3 may perform configuration of the detector modules by setting which detectors are to be applied, e.g. indicating specific one or more cascade classifiers to be used for detection. In an example embodiment these classifiers may correspond to specific OpenCV XML files, such as haarcascade_frontalface_al.xml, haarcascade_profileface.xml, etc. when the Primary Anchor Detector 157 performs a Full Detection Task 147. In this cascade based system, for each anchor the one or more classifiers (illustrated by blocks 340, 350) will be applied, according to the detector configuration, and their results will be evaluated to determine whether the anchor corresponds to a detection.

The Secondary Anchor Detector 167 can make use of the same Spatial Early Exit to avoid any detection task when possible, but if there is no conclusive decision the Simplified Detection task 187 is performed. When multiple classifiers are used, the simplified task may use only a subset of these classifiers (illustrated in blocks 360, 370) as indicated by detection data corresponding to primary anchors in the vicinity of the current anchor. In a non limiting example, if for one adjacent primary anchor a face was detected for classifier J, while for another adjacent primary anchor no face was detected, we may apply only classifier J to the current anchor, thus reducing the number of classifiers to apply and making the process more efficient, or alternatively, we may change the processing order, starting with classifier J—to allow for early exit in the case of a positive detection. In yet another non limiting example, we may configure the face detection to use multiple profile and frontal cascades, but attempt to detect only profile or only face in the simplified detection, according to the detection types in the adjacent primary anchors.

As explained above, for multi-scale cascade based face detection either the image is scaled for each scale to be used, or the classifiers are scaled and applied at the same image resolution. In an example embodiment, as part of setting up the detector, the configurator 110 sets the classifiers or cascades to be used, as well as a stepSize and the scales or scaling factors. In order to increase the detector system efficiency it can be beneficial upon initialization to run a Classifier Pyramid Calculator 320, which for each cascade performs scaling to all the target scale factors, storing a set of scaled cascades in the Classifier Pyramid Data 330. This saves having to recalculate these scaled classifiers for each frame and each scale (or performing scaling of the image to each scale), making the overall process more efficient.

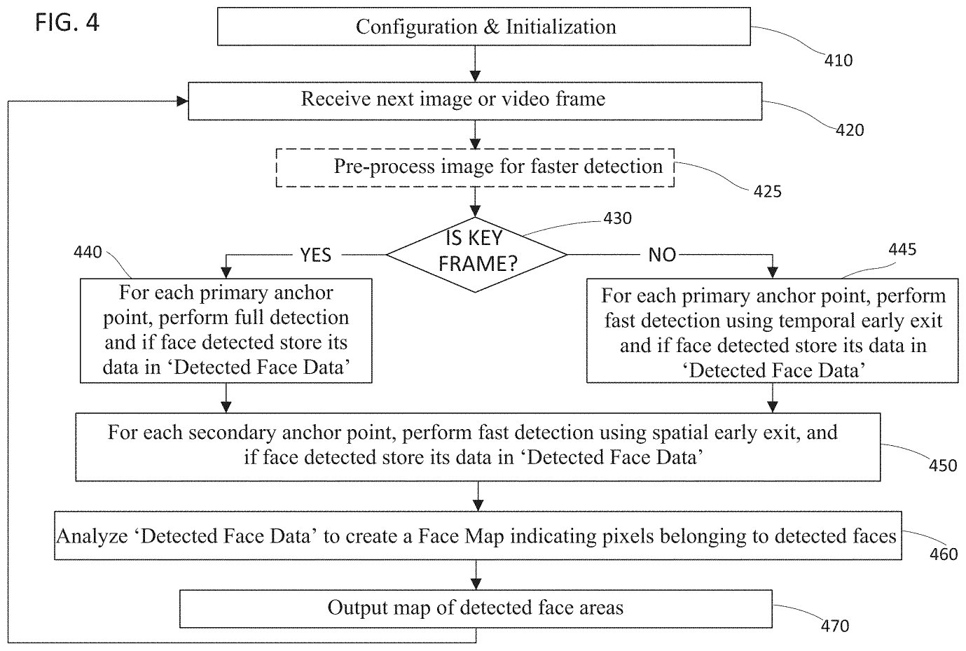

Turning now to FIG. 4, there is illustrated a generalized flowchart of a face detection system in accordance with certain embodiments of the presently disclosed subject matter. The first step is to perform Configuration and Initialization of the face detector, depicted in block 410. Configuration may comprise setting up the face detector processes to be used. For example, setting the target face size(s), configuring the step size to be used and the different scales. Configuration may further comprise setting the detection cascades to be used by the detectors. In some embodiments, in conjunction with the configuration we may also perform calculation of a pyramid of cascades, to store each cascade at each scale, rather than performing the scaling for each image, thus increasing efficiency of the system. Initialization may comprise creating a list of anchor points. The anchor points correspond to all positions on the image where block face detection will be performed. When performing multi-scale face detection, each anchor point corresponds to a particular position, as determined by the stepSize between examined positions, coupled with a specific scale. The Initialization may further comprise splitting the anchor points into one primary group and one or more secondary groups. This full list of anchors will be the basis for the detection in all frames.

Then for each video frame or image in the sequence, the next frame is obtained as depicted in block 420. This image may be placed into the Image/Video Frame Storage 130. When certain filters are used by the detectors it is possible to add a pre-process step as depicted in block 425. For example, when using Haar for the low level features, an integral image may be computed which allows for very efficient calculation of the Haar features.

Next, in 430, we determine whether the frame is to be handled as a key frame or not. For key frames the process depicted in block 440 is applied, wherein for each anchor point in the primary sub-set, a full detection process is launched. By way of a non limiting example, this may correspond to applying each of the multiple cascades set in the configuration stage for each anchor. If a face is detected in an anchor the Detected Face Data is updated accordingly, indicating the detection for the anchor as well as accompanying information such as which cascade yielded a positive detection and at which scale. If this is not a key frame, information from previous frames is used as depicted in 445. First, the possibility of temporal early exit is evaluated, followed if needed by simplified detection process, to reduce the computational cost of the detection. At the end of this block if the anchor corresponds to face, the Face detection Data will be updated accordingly. Further details on temporal early exit evaluation and corresponding simplified detection will be provided in conjunction with the description of FIG. 6.

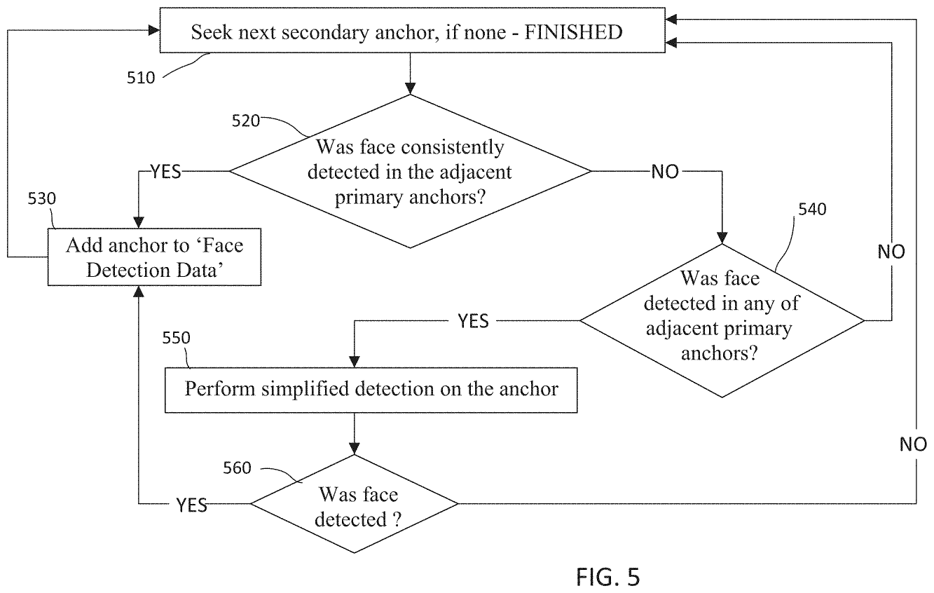

Proceeding to process the one or more secondary set, a fast detection process is launched for each anchor in a secondary sub-set as depicted in block 450. The fast detection utilizes information from primary anchors which are adjacent, or in the vicinity of the secondary anchor being processed. First, the possibility of spatial early exit is evaluated, followed if needed by simplified detection process, to reduce the computational cost of the detection. At the end of this block if the anchor corresponds to face, the Face detection Data will be updated accordingly. Further details on spatial early exit evaluation and corresponding simplified detection will be provided in conjunction with the description of FIG. 5.

After processing all anchors of the frame, giving rise to the Detected Face Data for the entire frame, we may decide in some embodiments to perform analysis of this data to yield a Face Map, which indicates pixels belonging to detected faces, as depicted in block 460. Further details on an example embodiment of creating the face map will be provided below in conjunction with FIG. 7.

Finally, in 470 the obtained Face Map can be output from the system, and we may proceed to the next frame, returning to block 420.

Turning now to FIG. 5 there is illustrated a generalized flowchart of spatial fast detection in accordance with certain embodiments of the presently disclosed subject matter. Accelerated spatial based face detection is applied to the anchors in a secondary sub-group of anchors. The process can be applied either sequentially as illustrated here in 510, or can be applied to all the anchors of a sub-group simultaneously, by using a control module or anchor launcher which spreads the tasks out on all available processors or on all available threads. A hybrid approach may also be utilized where according to number of available threads or processes, a group of anchors are launched simultaneously, and such groups are sequentially launched until all anchors in the sub group were processed. The advantage of this flexible parallelization is the ability to use highly parallelized infrastructure, such as GPU, to obtain very low latency face detection.

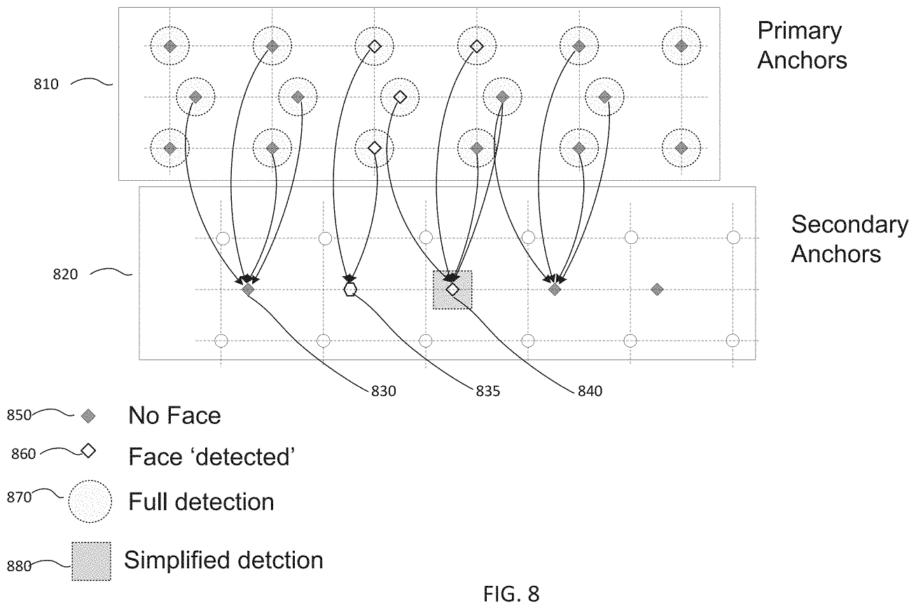

Next, the possibility of spatial early exit is evaluated as depicted in 520. Different criteria to determine detection based only on detection results of the adjacent anchors of the primary set may be set forth. For example, if face was consistently detected in the adjacent anchors of the primary set, we may determine that this anchor also corresponds to face, and the anchor will be added to the Face Detection Data as depicted in block 530. If this condition does not hold, in another example, if face was not detected for any of the adjacent primary anchors, we may determine that this anchor does not correspond to face as depicted in 540. In both these cases no further detection is required, resulting in a significant reduction of computational cost. Further explanations and examples of consistent detection in adjacent primary set anchors will be provided below in conjunction with the description of FIG. 8.

If early exit is not possible, for instance due to inconsistent detection in the vicinity of the current anchor, we may proceed to a simplified detection task 550. This task is simplified due to the availability of some prior knowledge from detection near the current anchor. For example, if there was a single face detection in the vicinity of this anchor, while this is not sufficient to make a detection decision, we may use information of this detection, to make the detection process more efficient. For example, if using a multi cascade detector the simplified detection may be performed by evaluating only with the cascade which yielded the positive detection for the adjacent primary anchor, or alternatively, starting with this cascade and in case of positive detection allowing for early exit.

If the simplifies detection resulted in a positive face detection, this anchor will be added to the Face Detection Data as depicted in block 530.

Turning now to FIG. 6 there is illustrated a generalized flowchart of temporal fast detection in accordance with certain embodiments of the presently disclosed subject matter. Accelerated temporal based face detection is applied to the primary anchors in non key frame. The process can be applied either sequentially as illustrated here in 610, or can be applied to all the anchors of a sub-group simultaneously, by using a control module or anchor launcher which spreads the tasks out on all available processors or on all available threads. A hybrid approach may also be utilized where according to number of available threads or processes, a group of anchors are launched simultaneously, and such groups are sequentially launched until all anchors in the sub group were processed. The advantage of this flexible parallelization is the ability to use highly parallelized infrastructure, such as GPU, to obtain very low latency face detection.

First, information regarding detected faces in the preceding one or more frames for the co-located anchor as well as surrounding anchors is collected as depicted in 620. This can be done by storing a face detection data structure for each processed frame, or alternatively, by having a single Detected Face Data structure which is updated at each frame but maintains a ‘memory’ mechanism, where, by way of a non-limiting example, detection data is all set to ‘none’ at initialization, and may also be reset periodically, and wherein any detection is retained for future frames.

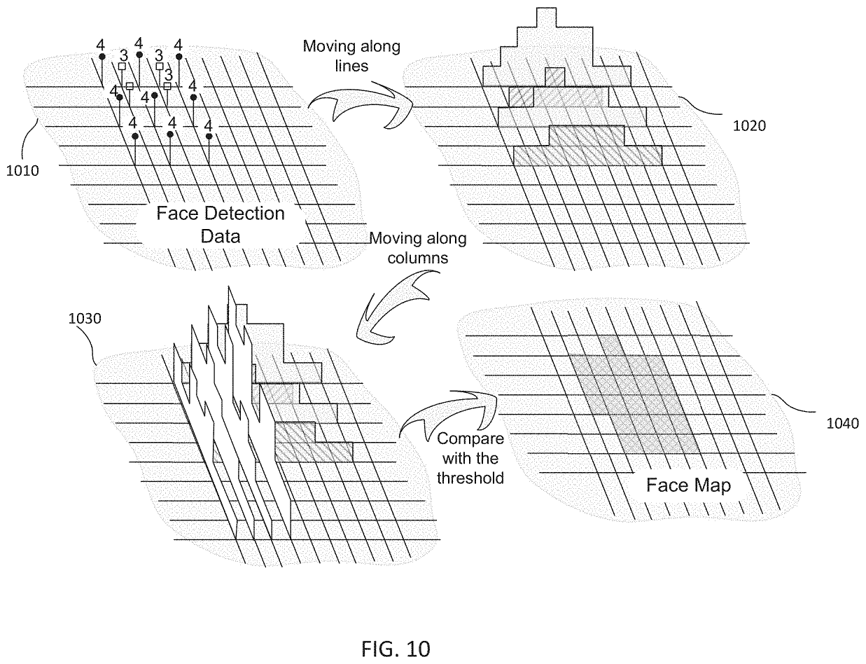

Then, in 640, obtained face detections are analyzed to determine whether there are face detections in this region. In some embodiments we may require only a single detection in order to proceed with simplified detection. In other embodiments we may require more detection to consider this anchor for simplified detection. If the condition to proceed with detection is not met, processing for this anchor is complete. Further details on temporal early exit will be provided below in conjunction with FIG. 10.

If early exit is not possible, for instance due to inconsistent detection in the vicinity of the current anchor, we may proceed to a simplified detection task 550. This task is simplified due to the availability of some prior knowledge from detection in the co-located and surrounding anchors in previous frame(s). For example, if there was a single face detection in the corresponding anchor, i.e. location and scale, in a previous frame, while this may not be sufficient to make a detection decision, we may use information of this detection to make the detection process more efficient. For example, if using a multi cascade detector the simplified detection may be performed be evaluating only at the scale and/or using some property of the detection—such as frontal vs. profile and/or using the specific cascade which yielded the positive detection for this previous anchor, or alternatively, starting with this scale and/or detection property, and in case of positive detection allowing for early exit.

If the simplified detection resulted in a positive face detection, this anchor will be added to the Face Detection Data as depicted in block 530.

Turning now to FIG. 7, there are illustrated concepts and components of Haar Cascade based face detection in accordance with certain embodiments of the presently disclosed subject matter. Some of these have been described above, however for the sake of completeness we will methodically review them here. When performing Haar based cascade detection of faces, the first step is often to calculate the outputs of the Haar filters. A few such filters are illustrated in 710. In 720, the suitability of these filters in detecting faces is illustrated by showing how in faces there are often rectangular areas with varying brightness, for example horizontal ‘stripes’ for eyes-nose-mouth as shown on the right. The output of Haar filters creates a large set of features, which can be used jointly to determine the presence of face. A full description of the cascade, the training and the application of the trained models to perform detection is well known and therefore out of the scope of this description. As the cascades pertain to a specific scale or face size, it is common to use multi scale detection if the size of faces is not known in advance. This is illustrated in 730.

A commonly used approach to detecting faces within an image, which have an unknown size and location within the image is to use multiscale detection combined with a scanning of potential origin points in the image, using a stepSize between candidate origin points. In 740 we show an example of these origin points and detection areas for a lower scale, while 745 illustrates the same for a larger scale.

Turning now to FIG. 8, there is illustrated an example of spatial early exit in accordance with certain embodiments of the presently disclosed subject matter. 810, on the top, shows a region of the images and a number of anchor points from the primary subset. In a multiscale detection scheme the illustration may correspond to anchors in a single scale, or to the accumulated data across multiple scales. The small diamonds indicate anchor points, where filled diamonds 850, correspond to anchors where no face was detected, while the empty diamonds, 860, correspond to anchors with positive face detection. For primary anchors, shown in 810, full detection as illustrated by the circle, 870, is performed for all anchors, and a non-limiting example of detection results is shown by the empty & filled diamonds. For secondary anchors, shown in 820, detection results can be determined solely on the basis of the results in adjacent primary anchors, while others require simplified detection as illustrated by the square 880.

We will now explain in more detail the specific example illustrated in FIG. 8. This is by no means intended to limit the scope of the presently disclosed subject matter and is merely to provide better understanding by way of example. In this example, four of the primary anchors in the examined area yielded a positive face detection. We now turn to the anchors of the mid row in the secondary anchor set of the same examined area, for which we have illustrated detection results of the surrounding primary anchors. Examining anchor 830, we see that face was not detected in any of the surrounding or adjacent primary anchors which contribute to this secondary anchor. The adjacent or neighboring primary anchors are indicated by the arrows leading to it, and in this example include the anchors above, below, to the left and to the right of the target secondary anchor. Thus, early exit is possible for this anchor, and we determine that it does not have face without performing actual detection. In other examples we could chose to take a wider range of primary anchors in the vicinity of the target secondary anchor and define various patterns that will be considered sufficient to conclude that the target anchor does not contain face. For example if a certain number of surrounding primary anchors do not contain face, or if anchors in a particular direction relative to the target anchor do not contain face etc. this will result in the target anchor being marked as not containing face, without the need for any further detection task.

Similarly, for anchor 835, examination of the surrounding or adjacent primary anchors show consistent face detection, which in this example corresponds to the fact that primary anchors both above and below the target anchor had face detected, which is considered a consistent detection around the target anchor. Therefore 835 is marked as having face, early exit is applicable, and no further detection is required. Note that this is just one example of consistent detection in the surrounding area or adjacent pixels. In another non limiting example if the anchors to the left and to the right both corresponded to detected face, we could assume that the target anchor corresponds to face. In other examples we could chose to take a wider range of primary anchors in the vicinity of the target secondary anchor and define various patterns that will be considered as consistent detection, for example if a certain number of surrounding primary anchors are positive, or if anchors in a particular direction relative to the target anchor are positive etc. this will result in the target anchor being marked as containing face, without the need for any further detection task.

While 830 and 835 are example where the spatial early exit can be applied to avoid further detection task, in some cases, exemplified here by anchor 840, it might not be possible to determine the presence of face based only on the surrounding or adjacent primary anchors, due to mixed detection results, as illustrated here by the arrows leading to the anchor. In such cases, the simplified detection 880 (which is an example of block 550 in FIG. 5) can be applied to this anchor. For example, if multiple cascades are used, the simplified detection may apply only cascades which yielded positive face detection in adjacent pixels. In another example, if multiple scales are used, simplified detection may comprise performing detection only at the scale where face was detected in adjacent pixels and/or adjacent scales. Similarly, any information that is available in the Face Detection Data from the anchors in the vicinity of or surrounding the target anchor, may be used to yield a faster detection process which requires less computations.

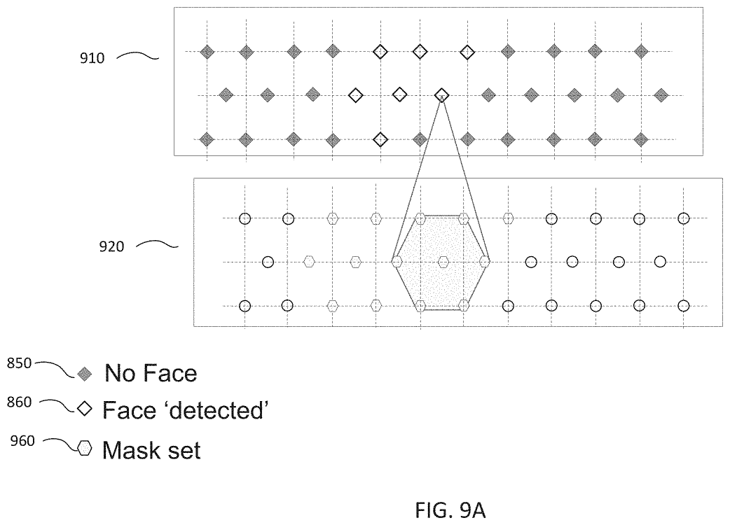

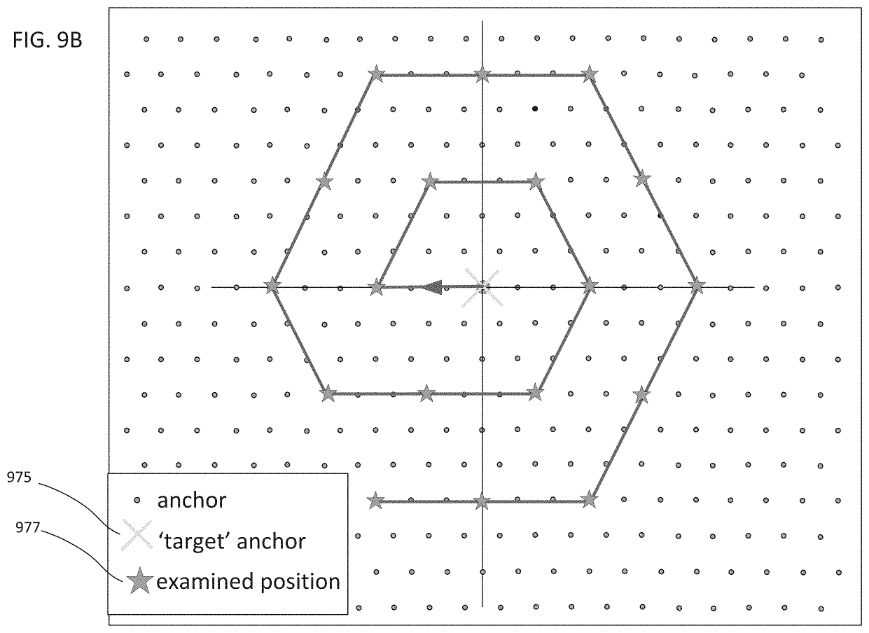

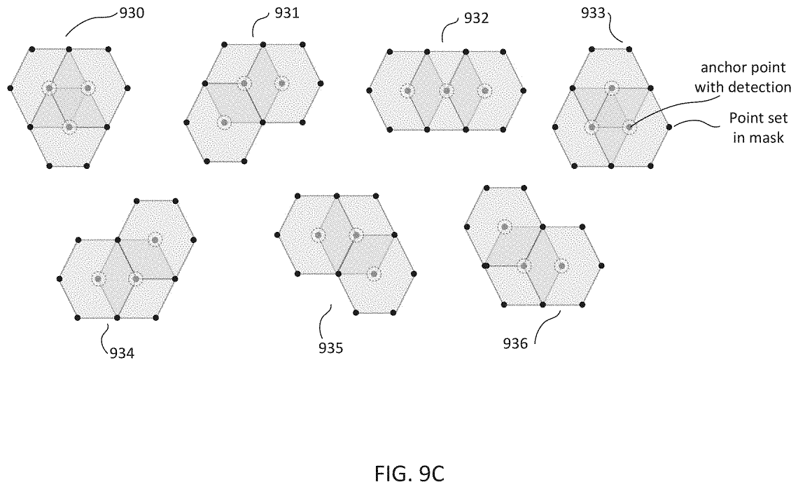

Turning now to FIG. 9A, there is illustrated an example of data preparation for temporal early exit in accordance with certain embodiments of the presently disclosed subject matter. On the top, 910 shows an example of anchors in a region of an example processed frame, where once again filled diamonds 850 indicate anchors where no face was detected, and empty diamonds 860 indicate anchors where face was detected. Based on these, a temporal face detection mask can be updated. For example, the mask update may be to set all the positions where face was detected. In another example, as illustrated here, we set the mask for all positions with face detection or adjacent thereto, here illustrated as those positions immediately next to positions with face detection, as indicated by the hexagons 970. Setting a position in the mask refers to updating it with information regarding the detection which may comprise one or more of a positive detection indication, the type of detection, the orientation—for example profile or frontal face, the size of the detected face, the scale it was detected at and any other information about the detection which we may want to utilize to reduce complexity of detections that refer to this position in the mask.

It is to be understood that any other scheme of setting the mask of detection may be used. This mask may be cleared on initialization, as well as being cleared or reset periodically—for instance at each key frame, thus using temporal data from multiple previous frames, or may be set for each frame individually implying usage of temporal data only from the most recent previous processed frame. This mask is an optional step in order to make using the information from co-located and surrounding anchors in preceding one or more images or video frames simpler. Thus, for processing of primary anchors when using temporal early exit, in an example embodiment, we may decide that any position where the mask is not set is determined to not include face, without any further detection process. In an example embodiment, we may decide that any position for which the mask is set face is marked as positive or detected. Alternatively, we may use a more conservative scheme where we perform simplified detection for the positions with set mask. This approach will yield very high performance, however has a drawback of not necessarily accounting for movement of faces between adjacent frames. To address this, and improve the detection accuracy, it is possible to perform a simplified search in the vicinity of positions where the mask is set, as will be explained next.

Turning now to FIG. 9B, there is illustrated an example of a possible implementation of temporal early exit further comprising spiral search, in accordance with certain embodiments of the presently disclosed subject matter. As mentioned above, it is possible for faces to move between consecutive frames, requiring examination of additional positions in the frame to those where the face was detected in previous frame(s). To achieve good tracking capability for moving faces, with minimal additional computations, a fast search approach with early exit can be used. In an example embodiment such a spiral search around a target anchor point may comprise examining the positions in a spiral pattern around the target anchor. If we encounter an examined position where the mask is set, then it is possible that the corresponding face has moved to the target anchor, and we perform a simplified detection for this target anchor, along the lines of the simplified search possibilities described above. For example the simplified detection may be guided by the detection information in the encountered set mask position, and we may perform detection only at the corresponding scale and/or using the corresponding cascade, orientation, size etc. If we complete the spiral, or alternatively cover all examined positions for this target and none of them are ‘set’, we do not perform any detection for the target anchor.

An example spiral search is shown in FIG. 9B. Here the large X, 975, indicates the target anchor for which detections with early temporal exit is being performed. The hexagonal shaped spiral line indicates the search spiral, with the examined positions, shown as stars 977.

This proposed implementation is highly efficient in cases of deep parallelization, such as when implementing on GPU, as each target anchor can be analyzed in a separate thread. For a CPU implementation, the spiral search may be replaced with a Look-Up-Table approach where we can easily determine if any of the examined positions correspond to a set mask position.

Turning now to FIG. 9C, there is illustrated a non limiting example, for the case where it is determined that a minimum of positive face detections in “close” anchors is required in order to confirm a face detection—a customary approach in Haar based systems. In this context, “close” anchors may indicate anchors that are in positions that are immediately next to each other, anchors in the same position with different scales or using different cascades, or a combination of these criteria. In this example, three adjacent positions yielding detection are required to confirm a positive face detection. In that case, assuming a mask obtained by the process described in conjunction with FIG. 9A, there is a minimal coverage of positions for each detection, as illustrated by the examples of FIG. 9C. This minimal coverage or footprint may be further utilized to create an optimal spiral geometry that gives maximum coverage with minimum points to be checked, as is illustrated in the example spiral of FIG. 9B, where the possible anchors positioned between each pair of neighboring anchors to be tested is assured to be covered by a minimal footprint from the possibilities illustrated in 930-936.

Turning now to FIG. 10, there is illustrated an example of the process of creating a Face Map using the information stored in the Face Detection Data in accordance with certain embodiments of the presently disclosed subject matter. In some cases it will be beneficial to output a binary face map indicating which pixels in the image correspond to face. Note that it is possible to also output the Detected Face Data directly from the system, making the creation of a face map a not necessary step or component of the system.

One way to generate a face map, is to replace the faces size values taken from the Detected Face Data Map with rectangular ‘bounding box’ areas, and then place all these areas on top of each other and identify the intersecting and overlapping area. However, this approach cannot be efficiently parallelized, as it requires using local loops, which can cause threads to compete for memory access. We therefore propose a different, parallelization friendly approach, detailed next.

A portion of the Face Detection Data is illustrated in 1010. For each position in the image where face is detected, there is a corresponding face size, where in this example we have detected faces of size 3 and 4. The face detection module first traverses the rows performing an accumulation of these values, such that if a position with a face of size N is encountered, for the next N pixels we add 1 to the value of the intermediate face map, and after N+1 pixels we no longer add this 1. If during these N pixels we encounter another position with a face of size M, we add 1 to the next M pixels, etc. In the illustrated example, this yields the result illustrated in 1020. Then the columns are traversed in a similar manner and added to the row results, which for this example yields the result illustrated in 1030. These steps result in a weighted, non binary face map, where the higher the value is, the higher the confidence that there is face present in that position. Finally, in a vertical pass, the accumulated values are compared with a preconfigured threshold, and any position for which the result of the previous stages exceeds the threshold is set to a ‘face pixel’ yielding, for this example, the binary face map illustrated in 1040.

Thus configured, these teachings provide for efficient face detection, such that faces can be found in one or more images or video frames, with reduced computational requirements, and/or using a reduced power to obtain accurate, low cost and fast face detection, when compared to a face detection system which does not utilize these teachings.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

It is to be noted that the examples and embodiments described herein are illustrated as non-limiting examples and should not be construed to limit the presently disclosed subject matter in any way.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable storage medium tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

The invention claimed is:

1. A computerized method for object detection in one or more video frames, the method comprising:
performing initialization comprising obtaining a data structure to hold object detection information for each position in a video frame, and a set of detection anchors each representative of at least a position in the video frame to be considered for detection, wherein the set of detection anchors is divided into a primary sub-set and one or more secondary sub-sets, and
for a given video frame of the one or more video frames, performing processing comprising:
for each detection anchor in said primary sub-set performing a full detection process, determining whether the detection anchor corresponds to a detected object, and updating the data structure according to said determination;
for each detection anchor in each secondary sub-set of said one or more secondary sub-sets, performing a partial detection process, comprising determining if a criterion for spatial early exit is met and whether the detection anchor corresponds to a detected object, and updating the data structure according to said determination; and
outputting said data structure providing the information on one or more detected objects.

2. The computerized method according to claim 1, wherein the detected object is a face.

3. The computerized method according to claim 2, wherein said initialization further comprises obtaining a face map to hold binary indications for respective positions in the video frame, and wherein upon completion of said processing, performing analysis of the data structure and updating the face map so that the binary indications correspond to positions where face was or was not detected in said given video frame.

4. The computerized method according to claim 2, wherein in cases where the given video frame is not considered a key-frame, said full detection process for detection anchors in said primary sub-set is replaced with a history-based partial detection process, by determining for each detection anchor in said primary sub-set if a criterion for temporal-based early exit is met and whether the detection anchor corresponds to a detected face, and updating the data structure according to said determination.

5. The computerized method according to claim 2, wherein the full detection process is a multi-scale cascade-based detection scheme, and wherein the initialization further comprises obtaining face detection cascades for each scale to be used, and wherein each detection anchor in said set of detection anchors further comprises a corresponding scale value.

6. The computerized method according to claim 1, wherein said set of detection anchors is divided into a primary sub-set and one or more secondary sub-sets such that the primary sub-set and the one or more secondary sub-sets are spatially interleaved.

7. The computerized method according to claim 6, wherein said primary sub-set and a secondary sub-set are spatially interleaved such that one sub-set corresponds to even detection anchor positions and the other to odd detection anchor positions.

8. The computerized method according to claim 2, wherein said criterion for spatial early exit comprises evaluating whether a face was consistently detected in one or more detection anchors in the primary sub-set that are adjacent to the detection anchor in the secondary sub-set.

9. The computerized method according to claim 8, wherein a face was consistently detected in response to the face being detected in the detection anchors in the primary sub-set on both sides of the detection anchor of the secondary sub-set.

10. The computerized method according to claim 4, wherein said criterion for temporal early exit comprises evaluating whether a face was detected in co-located or surrounding detection anchors in one or more preceding video frames of the given video frame.

11. A computerized system for object detection in one or more video frames, the system comprising a processor configured to:
perform initialization comprising obtaining a data structure to hold object detection information for each position in a video frame, and a set of detection anchors each representative of at least a position in the video frame to be considered for detection, wherein the set of detection anchors is divided into a primary sub-set and one or more secondary sub-sets, and
for a given video frame of the one or more video frames, perform processing comprising:
for each detection anchor in said primary sub-set performing a full detection process, determining whether the detection anchor corresponds to a detected object, and updating the data structure according to said determination;
for each detection anchor in each secondary sub-set of said one or more secondary sub-sets performing a partial detection process, comprising determining if a criterion for spatial early exit is met and whether the detection anchor corresponds to a detected object, and updating the data structure according to said determination; and
output said data structure providing the information on one or more detected objects.

12. The computerized system according to claim 11, wherein the detected object is a face.

13. The computerized system according to claim 12, wherein said initialization further comprises obtaining a face map to hold binary indications for respective positions in the video frame, and wherein upon completion of said processing, performing analysis of the data structure and updating the face map so that the binary indications correspond to positions where face was or was not detected in said given video frame.

14. The computerized system according to claim 12, wherein in cases where the given video frame is not considered a key-frame, said full detection process for detection anchors in said primary subset is replaced with a history-based partial detection process, by determining for each detection anchor in said primary sub-set if a criterion for temporal-based early exit is met and whether the detection anchor corresponds to a detected face, and updating the data structure according to said determination.

15. The computerized system according to claim 12, wherein the full detection process is a multi-scale cascade-based detection scheme, and wherein the initialization further comprises obtaining face detection cascades for each scale to be used, and wherein each detection anchor in said set of detection anchors further comprises a corresponding scale value.

16. The computerized system according to claim 11, wherein said set of detection anchors is divided into a primary sub-set and one or more secondary sub-sets such that the primary sub-set and the one or more secondary sub-sets are spatially interleaved.

17. The computerized system according to claim 12, wherein said criterion for spatial early exit comprises evaluating whether a face was consistently detected in one or more detection anchors in the primary sub-set that are adjacent to the detection anchor in the secondary sub-set.

18. The computerized system according to claim 17, wherein a face was consistently detected in response to the face being detected in the detection anchors in the primary sub-set on both sides of the detection anchor of the secondary sub-set.

19. The computerized system according to claim 14, wherein said criterion for temporal early exit comprises evaluating whether face was detected in co-located or surrounding detection anchors in one or more preceding video frames of the given video frame.

20. A non-transitory computer readable storage medium tangibly embodying a program of instructions that, when executed by a computer, cause the computer to perform a method of object detection in one or more video frames, the method comprising:
perform initialization comprising obtaining a data structure to hold object detection information for each position in a video frame, and a set of detection anchors each representative of at least a position in the video frame to be considered for detection, wherein the set of detection anchors is divided into a primary sub-set and one or more secondary sub-sets, and
for a given video frame of the one or more video frames, perform processing comprising:
for each detection anchor in said primary sub-set performing a full detection process, determining whether the detection anchor corresponds to a detected object, and updating the data structure according to said determination;
for each detection anchor in each secondary sub-set of said one or more secondary sub-sets, performing a partial detection process, comprising determining if a criterion for spatial early exit is met and whether the detection anchor corresponds to a detected object, and updating the data structure according to said determination; and
output said data structure providing the information on one or more detected objects.
